(19) United States
(12) Patent Application Publication
(10) Pub. No.: US 2026/0086430 A1
(43) Pub. Date: Mar. 26, 2026

(54) ROTATABLE CONTROL ASSEMBLY AND LENS PARAMETER ADJUSTMENT DEVICE

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/331,757

(22) Filed: Sep. 17, 2025

(30) Foreign Application Priority Data
Sep. 26, 2024 (CN) 2024223706634

(51) Int. Cl. G03B 13/32; G02B 27/64; H04N 23/68

(52) U.S. Cl. CPC G03B 13/32; G02B 27/646; H04N 23/685

(57) ABSTRACT

A lens parameter adjustment device includes a main body and a rotatable control assembly. The damping strength of the rotatable control assembly can vary according to the rotation angle, hereby enabling the lens parameter adjustment device to meet the damping tactile feedback needs of different users.

### CROSS-REFERENCE TO RELATED APPLICATIONS

The present application for patent claims priority to and the benefit of pending Chinese Application No. 2024223706634, which is filed on September 26, 2024, and hereby expressly incorporated by reference herein as if fully set forth below in its entirety and for all applicable purposes.

### TECHNICAL FIELD

The present disclosure pertains to the field of photographic auxiliary equipment, and in particular to a rotatable control assembly and a lens parameter adjustment device.

### INTRODUCTION

During photography, users often need to adjust lens parameters such as zoom, focus, and aperture to achieve different compositions. This is generally accomplished by rotating the lens to capture the desired image. To facilitate such adjustments, parameter adjustment devices such as follow focus units have been developed. These devices generally include a main body and a handwheel, with the main body and handwheel communicatively connected, allowing the user to hold the main body with one hand while adjusting the handwheel with the other, rotating it to a specific angle. The angle data is then transmitted to the main body to adjust the lens parameters. Although existing follow focus systems can adjust lens parameters, they are somewhat deficient in providing corresponding operational feedback to the user, such as damped tactile response. Typically, damping grease or oil is applied between the rotating and fixed parts of the handwheel to achieve a damping effect. However, while this approach provides damping between the rotating and fixed parts, it lacks adjustability in damping strength, making it difficult to meet the tactile feedback preferences of different users.

### BRIEF SUMMARY

To address the issues above, aspects of the present disclosure provide a rotatable control assembly with variable damping strength according to the rotation angle, thereby offering improved adjustability.

Some aspects of the present disclosure provide a lens parameter adjustment device that can accommodate the damping tactile feedback preferences of different users.

The present disclosure provides a rotatable control assembly, including:

a fixed assembly;

a rotating assembly, including a rotating member, an adjustment member, and a rotating shaft, wherein the rotating member is rotatably connected to the fixed assembly via the rotating shaft;

a damping assembly, including a pressure-applying member and a damping member, wherein the damping member is located between the fixed assembly and the pressure-applying member, the pressure-applying member is rotatably arranged on the rotating shaft and is capable of abutting the damping member; the pressure-applying member is configured to move axially relative to the rotating shaft during rotation, and the adjustment member is mounted on the pressure-applying member; when rotated by an external force, the adjustment member drives the pressure-applying member to rotate, causing it to move axially relative to the rotating shaft, abut the damping member, and alter the contact area between the damping member and the fixed assembly.

The present disclosure also provides a lens parameter adjustment device, including a main body and the aforementioned rotatable control assembly, wherein a side of the fixed assembly facing away from the rotating member is connected to the main body, a side of the fixed assembly facing the main body is provided with a first communication module, a side of the main body facing the fixed assembly is provided with a second communication module, and the first communication module and the second communication module are configured to be electrically connected.

Compared with the present disclosure, the damping strength of the rotatable control assembly can vary according to the rotation angle, offering excellent adjustability, thereby enabling the lens parameter adjustment device to meet the damping tactile feedback needs of different users.

### BRIEF DESCRIPTION OF THE DRAWINGS

FIG. 1 is a diagram illustrating a focus unit according to some aspects of the disclosure.

FIG. 2 is a cross-sectional view of the follow focus unit.

FIG. 3 is a diagram illustrating a main body from a first perspective according to some aspects of the disclosure.

FIG. 4 is a diagram illustrating the main body from a second perspective according to some aspects of the disclosure.

FIG. 5 is a diagram illustrating a rotatable control assembly according to some aspects of the disclosure.

FIG. 6 is an exploded view of the rotatable control assembly of FIG. 5 without a rotation gear adjustment assembly according to some aspects of the disclosure.

FIG. 7 is an exploded view of a second rotating part, a rotating shaft, a damping part, a transmission part, and a third rotating shell according to some aspects of the disclosure.

FIG. 8 is an exploded view of a first connector, a pressure-applying member, and a washer according to some aspects of the disclosure.

FIG. 9 is a diagram illustrating an assembled state of the damping part and the third rotating shell according to some aspects of the disclosure.

FIG. 10 is a diagram illustrating an assembled state of the damping part and the third rotating shell in another embodiment.

FIG. 11 is a cross-sectional view of the rotatable control assembly according to some aspects of the disclosure.

FIG. 12 is a cross-sectional view of the rotatable control assembly with an elastic member according to some aspects of the disclosure.

FIG. 13 is a diagram illustrating an assembled state of the rotation gear adjustment assembly and the adjustment member according to some aspects of the disclosure.

FIG. 14 is a schematic view of the rotation gear adjustment assembly.

Reference numerals: 100. follow focus unit; 1. rotatable control assembly; 11. first communication module; 111. circuit board; 112. first communication terminal; 12. rotating assembly; 121. rotating shaft; 122. magnet; 123. rotating member; 1231. through hole; 1232. mounting part; 1233. limiting part; 1234. accommodating groove; 1235. mounting hole; 124. adjustment member; 1241. adjustment knob; 12411. hand-grip part; 12412. connection part; 1242. first connector; 12421. protrusion part; 12422. annular part; 12423. positioning hole; 125. detent ball; 126. limiting detent groove; 127. first rotating member; 128. second rotating member; 1281. first rotating part; 12811. first rotating shell; 12812. second rotating shell; 12813. third rotating shell; 12814. first rotation limiting protrusion; 1282. second rotating part; 1283. protrusion; 129. movement groove; 13. fixed assembly; 131. fixed plate; 1311. protruding post; 132. bearing; 133. base plate; 14. damping assembly; 141. pressure-applying member; 1411. positioning protrusion; 1412. pressure platform; 1413. step surface; 1414. internal threaded hole; 142. damping member; 1421. damping part; 14211. damping support arm; 1422. transmission part; 1423. first limiting groove; 1424. elastic member; 1425. second limiting groove; 143. washer; 15. rotation gear adjustment assembly; 151. adjustment lever; 152. moving member; 153. gear limiting switch; 154. actuating protrusion; 155. first engagement groove; 156. second engagement groove; 157. second rotation limiting protrusion; 2. main body; 21. second communication module; 211. second communication terminal; 22. zoom adjustment module; 23. aperture adjustment module; 24. ND filter adjustment module.

### DETAILED DESCRIPTION

To further illustrate various aspects, the following description is provided with reference to the accompanying drawings and illustrative examples. It should be understood that the specific embodiments described herein are provided for the purpose of illustration and not intended to limit the scope of the present disclosure.

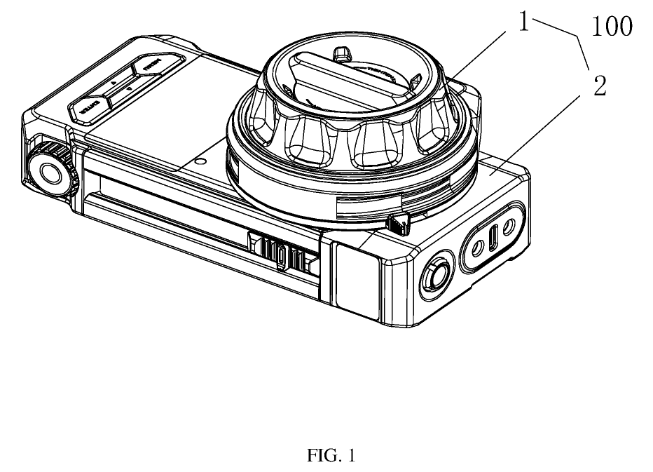

Referring to FIG. 1, aspects of the disclosure provide a lens parameter adjustment device, such as a follow focus unit 100. The follow focus unit 100 is configured for wireless connection with a follow focus execution terminal installed on a photographic device, such as a camera or still camera. The follow focus execution terminal is typically a motor that engages with the focus ring or aperture adjustment ring of the photographic device. The follow focus unit 100 remotely controls the follow focus execution terminal to enable the photographic device to adjust zoom, focus, or the aperture ring.

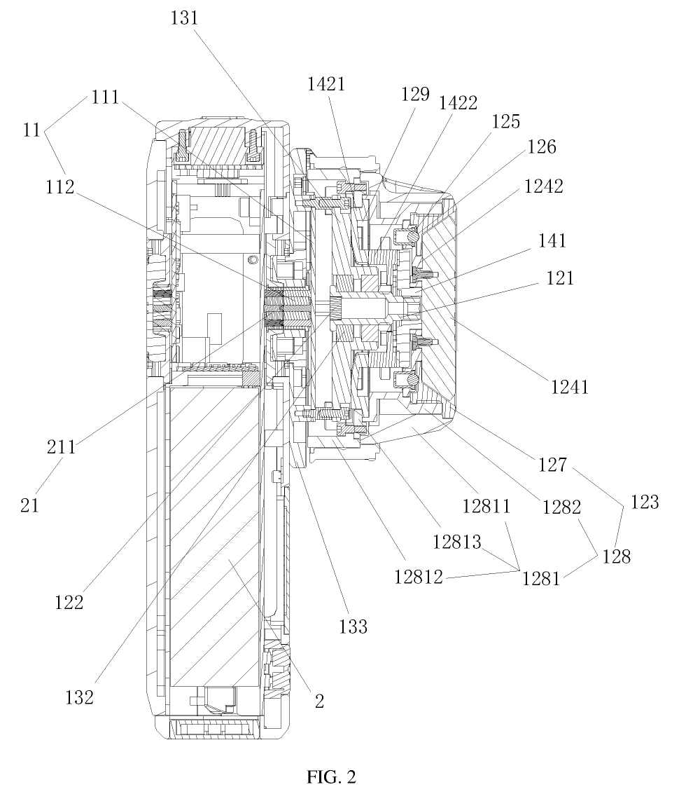

In some aspects, referring to FIG. 2, the follow focus unit 100 includes a rotatable control assembly 1 and a main body 2. The rotatable control assembly 1 (e.g., a knob structure) includes a first communication module 11. The main body 2 includes a second communication module 21. The first communication module 11 includes a circuit board 111 and a first communication terminal 112. The second communication module 21 includes a second communication terminal 211 and a controller (not shown). The circuit board 111 can be electrically connected to the first communication terminal 112. The first communication terminal 112 can be electrically connected to the second communication terminal 211. The second communication terminal 211 can be electrically connected to the controller. An encoder (not shown) can be provided on the circuit board 111. The rotatable control assembly 1 includes a rotating assembly 12. The rotating assembly 12 includes a rotating shaft 121. A magnet 122 is provided inside the rotating shaft 121 and cooperates with the encoder. During operation of the follow focus unit 100, lens parameters can be adjusted by rotating the rotating assembly 12. When the rotating assembly 12 rotates, the encoder detects the rotation angle of the magnet 122, thereby determining the adjustment angle of the rotatable control assembly 1. The adjustment angle is then fed back to the controller of the main body 2 via the first communication terminal 112 and the second communication terminal 211. The controller issues corresponding control commands to direct the photographic device to adjust the zoom, focus, and/or aperture ring, thereby adjusting lens parameters.

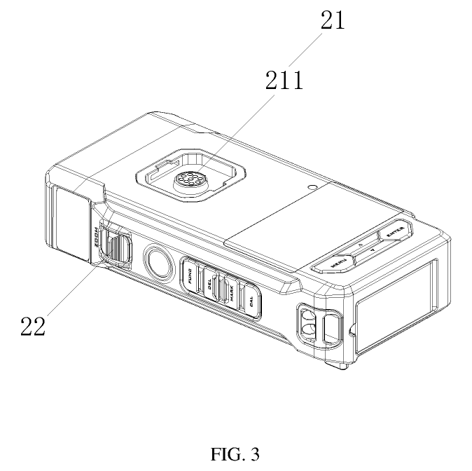

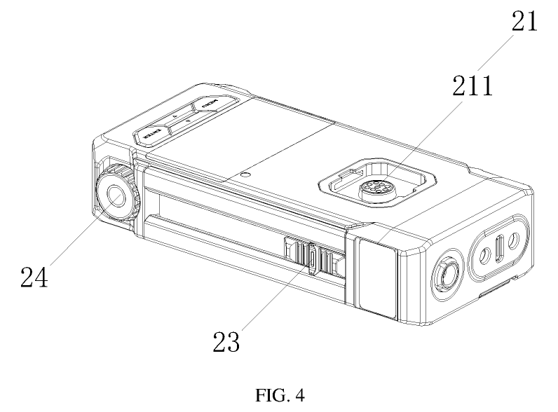

In some aspects, referring to FIGS. 3-4, the main body 2 can include a zoom adjustment module 22, an aperture adjustment module 23, and an ND filter adjustment module 24. The zoom adjustment module 22, aperture adjustment module 23, and ND filter adjustment module 24 can all be connected to the controller of the second communication module 21. In some aspects, the zoom adjustment module 22 utilizes a pressure sensor for focal length adjustment, and the aperture adjustment module 23 operates on the principle of a magnetic encoder for aperture adjustment. Through these modules, zoom, aperture, and ND filter adjustments can be performed directly on the main body 2 of the follow focus unit 100, enriching the functionality of the unit and expanding its application scenarios.

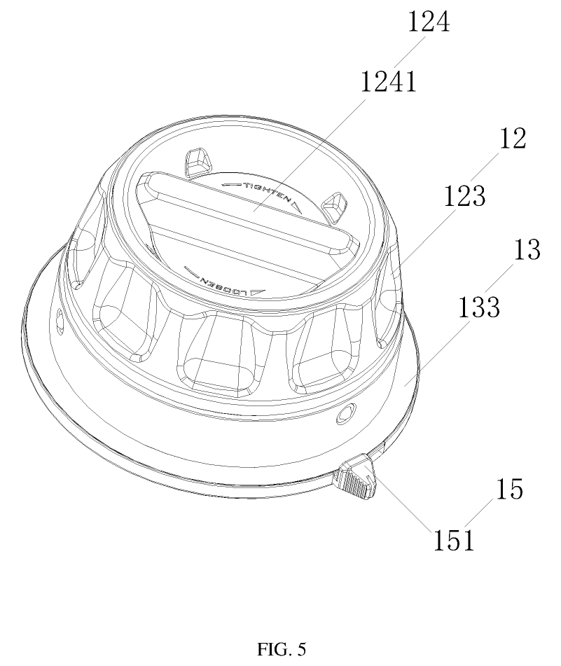

In some aspects, referring to FIGS. 2 and 5-11, the rotatable control assembly 1 can include a fixed assembly 13 and a damping assembly 14. The rotating assembly 12 includes a rotating member 123 and an adjustment member 124. The rotating member 123 can be rotatably connected to the fixed assembly 13 via the rotating shaft 121. The damping assembly 14 includes a pressure-applying member 141 and a damping member 142. The adjustment member 124 is mounted on the pressure-applying member 141—for example, via a shape fit, interference fit, or fixed connection, among other methods. The pressure-applying member 141 can be threadedly connected to the rotating shaft 121 and presses against the damping member 142. The damping member 142 is disposed between the fixed assembly 13 and the pressure-applying member 141. This configuration allows that by rotating the adjustment member 124, the pressure-applying member 141 is driven to move axially along the rotating shaft 121, compressing the damping member 142 and changing the contact area between the damping member 142 and the fixed assembly 13, thereby adjusting the damping effect. In this embodiment, the adjustment member 124 is used to adjust the damping strength, and the rotating member 123 is used to adjust lens parameters.

During operation of the rotatable control assembly 1, an external force is first applied to rotate the adjustment member 124. As the user typically holds the rotating member 123 with one hand and turns the adjustment member 124 with the other, the rotating member 123 and the rotating shaft 121 do not rotate together with the adjustment member 124. The pressure-applying member 141 moves axially along the rotating shaft 121 to adjust the damping strength. Different rotation angles of the adjustment member 124 result in different axial displacements of the pressure-applying member 141, varying the contact area between the damping member 142 and the fixed assembly 13, and consequently producing different damping strengths. After adjusting the damping strength, lens parameters can be adjusted by controlling the rotation angle of the rotating member 123. When rotating the rotating member 123, the user typically holds the main body 2 or the fixed assembly 13 with one hand and rotates the rotating member 123 with the other. The adjustment member 124 rotates together with the rotating member 123 and the rotating shaft 121. Thus, no relative movement occurs between the rotating member 123 and the rotating shaft 121, the damping strength remains constant, and only lens parameter adjustment is performed. Based on this structural design, the damping tactile feedback experienced by the user when rotating the rotating member 123 can vary according to the rotation angle of the adjustment member 124, offering adjustability. A greater rotation angle of the adjustment member 124 results in stronger damping feedback experienced by the user, making further rotation more difficult. This enables the lens parameter adjustment device to meet the damping tactile feedback needs of different users.

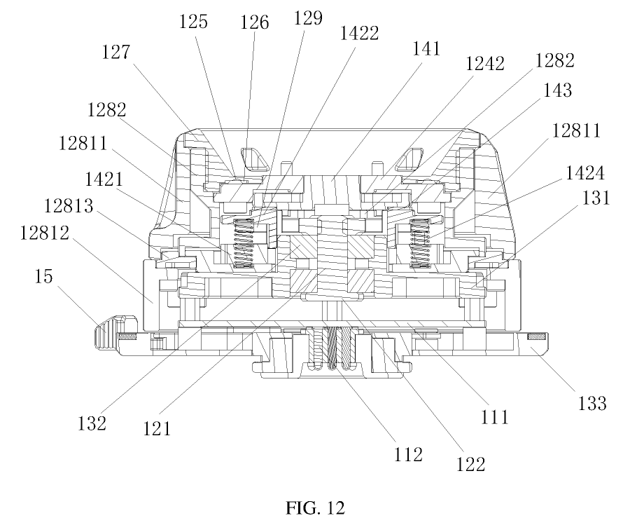

Referring to FIG. 12, in one embodiment, the damping member 142 includes a damping part 1421 and a transmission part 1422, which are separate components. The damping part 1421 is disposed between the transmission part 1422 and the fixed assembly 13. The rotating member 123 can be fixedly connected to the rotating shaft 121 and is provided with a through hole 1231. The transmission part 1422 is configured to extend through the through hole 1231. One side of the transmission part 1422 is configured to abut against the pressure-applying member 141, and at least one elastic member 1424 is disposed between its other side and the damping part 1421. The pressure-applying member 141 presses the transmission part 1422 via axial movement, causing it to compress the elastic member 1424, thereby pressing the damping part 1421 toward the fixed assembly 13. In some aspects, the elastic member 1424 may include multiple springs. Springs generally exhibit linear deformation characteristics, enabling the damping adjustment process to correspond to a linear adjustment profile. In this embodiment, when the user rotates the adjustment member 124, it drives the pressure-applying member 141 to rotate relative to the rotating shaft 121, resulting in axial movement along the rotating shaft 121. Consequently, the pressure-applying member 141 presses the transmission part 1422, which in turn compresses the elastic member 1424. The opposite end of the elastic member 1424 then presses against the damping part 1421, thereby adjusting the damping force between the fixed assembly 13 and the rotating assembly 12. Furthermore, the transmission part 1422 extends through the through hole 1231 of the rotating member 123, and the damping part 1421 is configured to be in limiting engagement with the rotating member 123. Thus, when the user rotates the rotating member 123, the damping part 1421 and the transmission part 1422 rotate in conjunction with the rotating member 123, allowing the user to perceive the damping tactile feedback. Specifically, as shown in FIG. 12, a plurality of elastic members 1424 can be connected between the transmission part 1422 and the damping part 1421, and these elastic members 1424 can be symmetrically arranged.

Referring to FIG. 2, in another implementation, the damping member 142 includes a damping part 1421 and a transmission part 1422, which are separate components. The damping part 1421 can be formed from an elastic material. It is disposed between the transmission part 1422 and the fixed assembly 13. The rotating member 123 can be fixedly connected to the rotating shaft 121 and is provided with a through hole 1231. The transmission part 1422 is configured to extend through the through hole 1231. The transmission part 1422 is located between the damping part 1421 and the pressure-applying member 141 and is configured to abut against both the damping part 1421 and the pressure-applying member 141, respectively. The pressure-applying member 141 presses the transmission part 1422 via axial movement, causing it to press the damping part 1421 toward the fixed assembly 13.

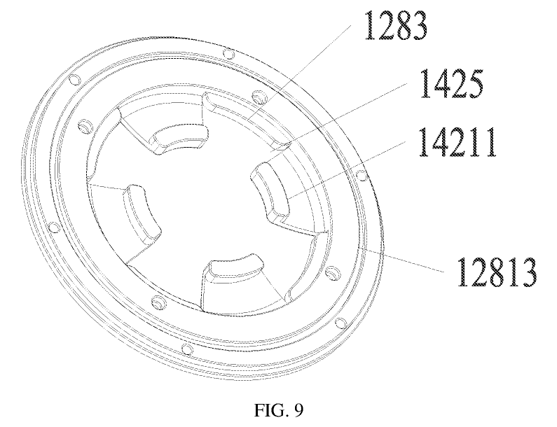

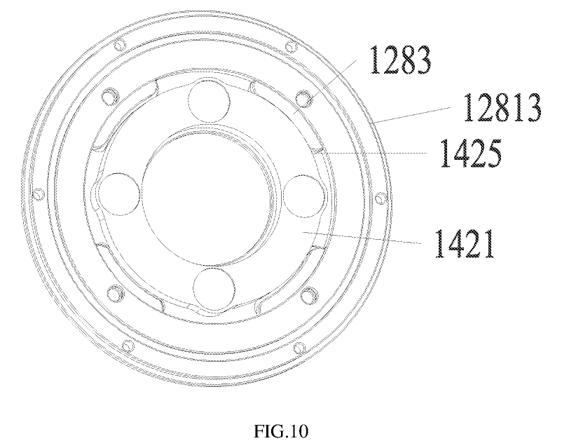

In some aspects, rotating the adjustment member 124 causes relative rotation between the rotating shaft 121 and the pressure-applying member 141. The pressure-applying member 141 moves axially relative to the rotating shaft 121, further pressing the transmission part 1422. The transmission part 1422 subsequently presses the damping part 1421. Since the damping part 1421 is made of an elastic material, the pressure applied by the transmission part 1422 alters the contact area between the damping part 1421 and the fixed assembly 13. For example, great pressure can increase the contact area. In both of the aforementioned embodiments, the provision of the through hole 1231 in the rotating member 123, through which the transmission part 1422 passes to abut against the pressure-applying member 141, enables the rotating member 123 to provide clearance via the through hole 1231 when the adjustment member 124 drives the pressure-applying member 141 to move axially by transmission. This prevents structural interference between the pressure-applying member 141 and the rotating member 123 during the axial movement of the pressure-applying member 141 against the transmission part 1422, thereby facilitating smooth damping adjustment. Circumferentially around the axis of the rotating shaft 121, the transmission part 1422 extends through the through hole 1231 so that it rotates in conjunction with the rotating member 123. In one aspect, referring to FIGS. 9-10, a protrusion 1283 is provided on the rotating member 123, and the damping part 1421 is provided with a second limiting groove 1425. The protrusion 1283 is configured to be received within the second limiting groove 1425, enabling the damping part 1421 to rotate with the rotating member 123. In some aspects, multiple protrusion 1283 can be included, and these multiple protrusions 1283 can engage the second limiting groove 1425 at multiple points on the outer periphery of the damping part 1421.

In the above two embodiments, an elastic member 1424 may or may not be provided between the damping part 1421 and the transmission part 1422. When no elastic member 1424 is present, the damping part 1421 itself, being an elastic body, possesses inherent elasticity. This facilitates deformation and rebound during damping adjustment and can simplify the structure. When an elastic member 1424 is provided, a spring or the like may be used as the elastic member 1424. Utilizing the linear deformation characteristics of a spring results in more uniform and smoother damping variation.

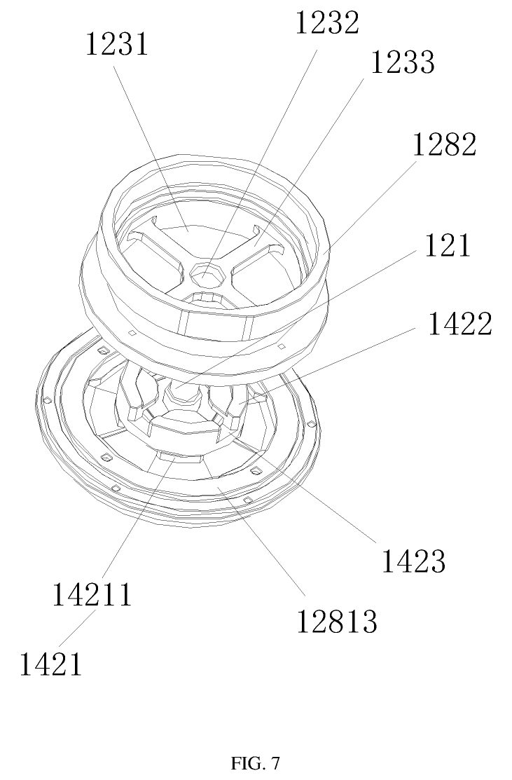

In some aspects, referring to FIG. 7, the rotating member 123 includes a mounting part 1232 and a limiting part 1233. The mounting part 1232 features a threaded hole structure, and the limiting part 1233 has a cross-shaped rib structure. The mounting part 1232 is located at the center of this cross-shaped rib structure. The rotating shaft 121 is fixedly mounted within the mounting part 1232 using threads; in some embodiments, adhesive fixation may also be employed. The transmission part 1422 includes a first limiting groove 1423 with a cross-shaped structure. The limiting part 1233 is movably disposed within the first limiting groove 1423. During axial movement of the transmission part 1422 along the rotating shaft 121, the first limiting groove 1423 cooperates with the limiting part 1233 to limit displacement, preventing positional deviation.

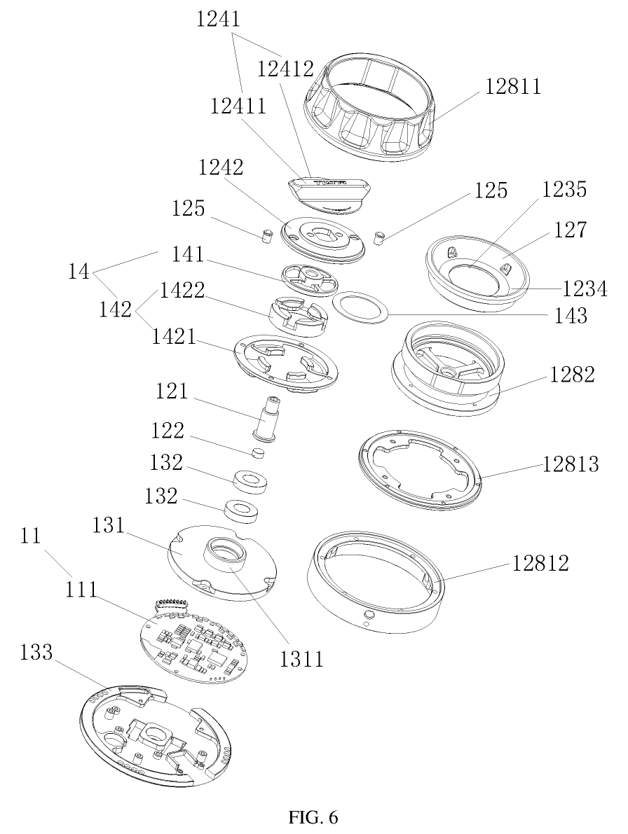

In some aspects, referring to FIG. 6, the adjustment member 124 includes an adjustment knob 1241 and a first connector 1242. A side of the rotating member 123 facing away from the fixed assembly 13 is provided with an accommodating groove 1234. The bottom of this accommodating groove 1234 has a mounting hole 1235. The adjustment knob 1241 is accommodated within the accommodating groove 1234. The first connector 1242 is accommodated within the mounting hole 1235 and can be fixedly connected to the adjustment knob 1241. The first connector 1242 and the pressure-applying member 141 are engaged via a shape-fit connection using hole positioning. Rotating the adjustment knob 1241 drives the first connector 1242 to rotate, and the rotation of the first connector 1242 in turn drives the pressure-applying member 141 to rotate. The adjustment knob 1241 is exposed on the rotating member 123 through the accommodating groove 1234. During use, the adjustment knob 1241 is manually turned from outside the rotatable control assembly 1, driving the first connector 1242 to rotate relative to the rotating member 123. The first connector 1242 then drives the pressure-applying member 141 to rotate threadedly relative to the rotating shaft 121. This causes the pressure-applying member 141 to move axially along the rotating shaft 121, either pressing against or moving away from the transmission part 1422. This action adjusts the contact area between the damping part 1421 and the fixed assembly 13 for damping adjustment. The structure is simple and compact, and adjustment is straightforward and convenient. It is noteworthy that, in this embodiment, the first connector 1242 and the pressure-applying member 141 are shape-fitted via a non-circular interface. In another embodiment, the first connector 1242 and the pressure-applying member 141 could also be connected via an interference fit or direct fixed connection.

In some aspects, referring to FIGS. 2 and 12, one of the opposing sides of the first connector 1242 and the rotating member 123 is equipped with a detent ball 125, and the other is provided with a plurality of limiting detent grooves 126 configured to receive the rounded end of the detent ball 125. Rotating the adjustment knob 1241 causes the detent ball 125 to move from one limiting detent groove 126 to another. This arrangement provides detent tactile feedback to the user when rotating the adjustment knob 1241. In this embodiment, the side of the first connector 1242 facing the adjustment knob 1241 is equipped with the detent ball 125, and the side of the rotating member 123 facing the detent ball 125 is provided with the plurality of limiting detent grooves 126. Rotating the adjustment knob 1241 causes the detent ball 125 to move between different limiting detent grooves 126. With this structure, when the adjustment knob 1241 is rotated, the first connector 1242 rotates relative to the rotating member 123, and the detent ball 125 sequentially engages different limiting detent grooves 126, providing detent feedback.

In some aspects, referring to FIGS. 2 and 6, the rotating member 123 includes a first rotating member 127 and a second rotating member 128. The first rotating member 127 and the second rotating member 128 can be fixedly connected by threads. The accommodating groove 1234 and the mounting hole 1235 are both provided on the first rotating member 127. The adjustment knob 1241 includes a hand-grip part 12411 and a connection part 12412. The first connector 1242 includes a protrusion part 12421 and an annular part 12422. The hand-grip part 12411 can be connected to the connection part 12412. The protrusion part 12421 extends through the mounting hole 1235 and can be fixedly connected to the connection part 12412. The annular part 12422 is disposed on the outer side of the protrusion part 12421. The detent ball 125 is installed on the annular part 12422.

In some aspects, referring to FIGS. 2, 6, and 11, the second rotating member 128 includes a first rotating part 1281 and a second rotating part 1282. The first rotating part 1281 and the second rotating part 1282 are fixedly connected by screws. The second rotating part 1282 is fixedly connected to the first rotating member 127 by threads, and the second rotating part 1282 is fixedly connected to the rotating shaft 121. The mounting part 1232 is provided on the second rotating part 1282. A movement groove 129 is formed between the first rotating part 1281 and the second rotating part 1282. The damping part 1421 is disposed within the movement groove 129. The first rotating part 1281, the damping part 1421, and the second rotating part 1282 are provided with through holes that are positionally aligned. Referring to FIG. 10, the first rotating part 1281 and the second rotating part 1282 are fixedly connected by screws that pass through the through holes of the damping part 1421. In the radial direction of the rotating shaft 121, rotation of the first rotating part 1281 and the second rotating part 1282 drives the damping part 1421 to rotate. Moreover, the damping part 1421 is movable within the movement groove 129 and can move axially relative to the first rotating part 1281 and the second rotating part 1282 along the rotating shaft 121. This structural design ensures that the damping part 1421 rotates with the first rotating member 127 while also allowing it to move axially along the rotating shaft 121, either approaching or moving away from the fixed assembly 13. This movement adjusts the contact area between the damping member 142 and the fixed assembly 13, thereby adjusting the damping strength.

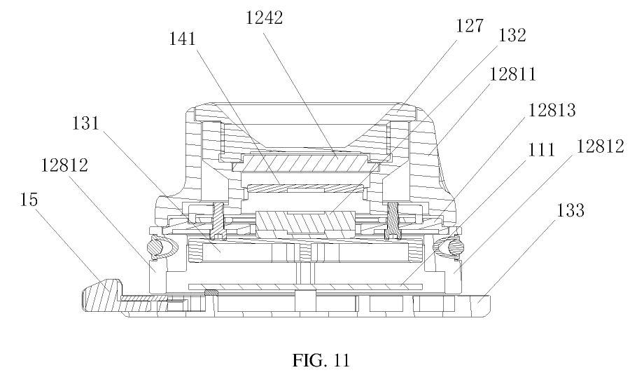

In some aspects, referring to FIGS. 2 and 11, the first rotating part 1281 includes a first rotating shell 12811, a second rotating shell 12812, and a third rotating shell 12813. The first rotating shell 12811 is annular and is positioned outermost. The second rotating part 1282 and the first rotating member 127 are both located inside the first rotating shell 12811. The second rotating shell 12812 and the third rotating shell 12813 are connected by screws. The third rotating shell 12813, the second rotating part 1282, and the damping part 1421 are connected by screws. The first rotating shell 12811 is clamped between the first rotating member 127 and the third rotating shell 12813, thus being stably sleeved on the outer ring of the second rotating part 1282 and fixed relative to it. The second rotating part 1282 and the first rotating member 127 have an interference fit. The second rotating part 1282 is fixedly connected to the rotating shaft 121 by threads. Through this design, rotating the outermost first rotating shell 12811 or the third rotating shell 12813 simultaneously drives the second rotating shell 12812, the third rotating shell 12813, the second rotating part 1282, the second rotating member 128, the first rotating member 127, and the rotating shaft 121 to rotate, thereby adjusting lens parameters. Conversely, the user can rotate the hand-grip part 12411, causing the pressure-applying member 141 to rotate relative to the rotating shaft 121. The pressure-applying member 141 moves axially along the rotating shaft 121 to adjust the damping strength. This design allows the user to experience different damping tactile feedback when rotating the first rotating shell 12811 or the third rotating shell 12813.

In some aspects, in one embodiment, the third rotating shell 12813 is provided with a protrusion 1283. The damping part 1421 includes several damping support arms 14211. A second limiting groove 1425 is formed between every two adjacent damping support arms 14211. The protrusion 1283 is accommodated within the second limiting groove 1425. The damping support arms 14211 are disposed between the transmission part 1422 and the fixed assembly 13, enabling the damping part 1421 to rotate with the first rotating part 1281. The damping support arms 14211 are elastic and can be displaced through deformation, adjusting their contact area with the fixed assembly 13 and thereby adjusting the damping strength. In another embodiment, the damping part 1421 adopts a planar structure provided with multiple second limiting grooves 1425. The protrusion 1283 provided on the third rotating shell 12813 is accommodated within the second limiting grooves 1425. The side of the damping part 1421 facing the transmission part 1422 is provided with an elastic member 1424, which can be a spring. One end of the spring abuts against or can be connected to the transmission part 1422, and the other end abuts against or can be connected to the damping part 1421. When the user rotates the adjustment member 124, it drives the pressure-applying member 141 to rotate relative to the rotating shaft 121, causing axial movement along the rotating shaft 121. Furthermore, the pressure-applying member 141 presses the transmission part 1422, which in turn compresses the elastic member 1424. The other end of the elastic member 1424 presses against the damping part 1421, thus adjusting the damping between the fixed assembly 13 and the rotating assembly 12. In both configurations described above, the third rotating shell 12813 engages with the second limiting groove 1425 via the protrusion 1283. During movement, the damping part 1421 is constrained by the cooperation between the protrusion 1283 and the second limiting groove 1425, while also achieving rotational fixation about the axis of the rotating shaft with the third rotating shell 12813, facilitating the driving of the damping part 1421 by the rotating member 123.

The above structural design enables the rotating member 123 to be composed of multiple separate rotating components. These components employ a split design and can be connected by screws or an interference fit. Each rotating component has its own function without interfering with others, making the structural relationship between the rotating member 123, the rotating shaft 121, the damping member 142, and the adjustment member 124 more flexible. Consequently, the overall structure of the rotatable control assembly 1 becomes more ingenious and compact.

In some aspects, referring to FIG. 6, the fixed assembly 13 includes a fixed plate 131. The side of the first communication module 11 facing away from the second communication module 21 can be connected to the fixed plate 131. The fixed plate 131 can be rotatably connected to the rotating shaft 121 via a bearing 132. The side of the damping part 1421 facing away from the pressure-applying member 141 abuts against the fixed plate 131.

In some aspects, the fixed plate 131 is provided with a protruding post 1311 on the side facing the damping assembly 14. The protruding post 1311 has a vertical through hole. The bearing 132 is installed within this hole, and the rotating shaft 121 passes vertically through the hole. The magnet 122 is located at the lower end of the rotating shaft 121 and is exposed through the hole, facing the circuit board 111, facilitating cooperation with the encoder on the circuit board 111. The protruding post 1311 serves to limit the position of the rotating shaft 121, ensuring its structural stability.

In some aspects, an installation space is formed around the periphery of the protruding post 1311. The damping part 1421 and the transmission part 1422 are provided with through holes to keep clear of the protruding post 1311, allowing them to be installed in this space. The protruding post 1311 also limits the vertical movement of the transmission part 1422, and the through holes prevent structural interference between the fixed plate 131 and the damping part 1421/transmission part 1422.

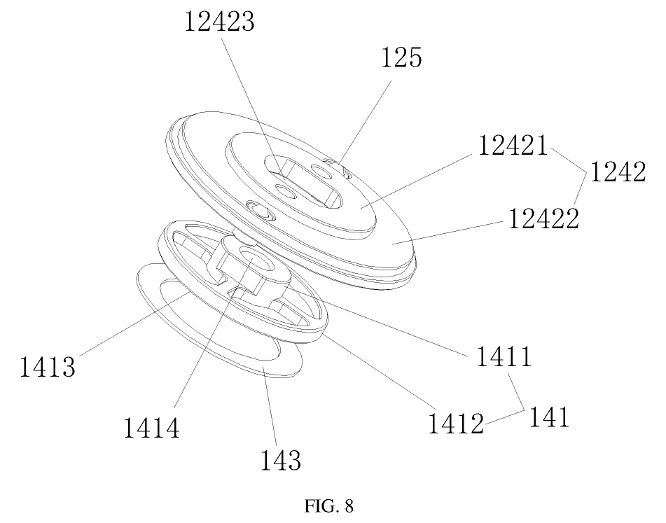

In some aspects, referring to FIGS. 7-8, the pressure-applying member 141 includes an integrally formed positioning protrusion 1411 and a pressure platform 1412. The first connector 1242 includes a positioning hole 12423 provided on the protrusion part 12421. The positioning protrusion 1411 extends through the positioning hole 12423 and engages with it via flat surfaces, ensuring fixation in the circumferential direction about the axis of the rotating shaft. The adjustment knob 1241 can drive the pressure-applying member 141 to rotate via the first connector 1242. The pressure platform 1412 abuts against the transmission part 1422. The pressure platform 1412 includes a washer 143. The surface of the pressure platform 1412 away from the positioning protrusion 1411 is provided with a step surface 1413 for mounting the washer 143, thereby preventing wear between the pressure platform 1412 and the transmission part 1422. The positioning protrusion 1411 is also provided with an internal threaded hole 1414. The pressure-applying member 141 can be connected to the rotating shaft 121 via this internal threaded hole 1414, allowing it to move axially relative to the rotating shaft 121 during rotation, thereby tightening or loosening the damping member 142.

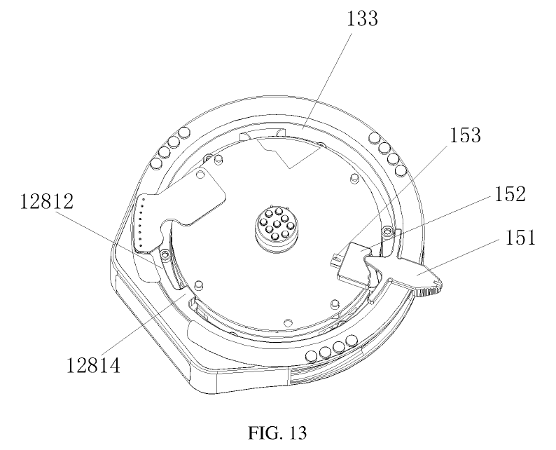

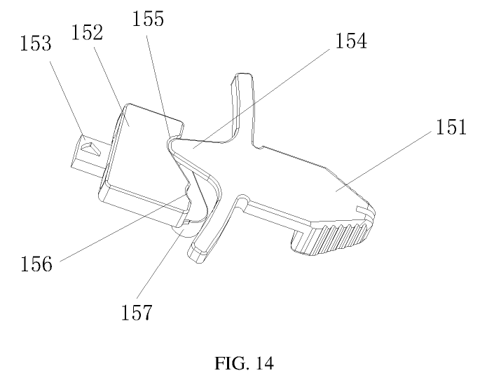

In some aspects, referring to FIGS. 13-14, the rotatable control assembly 1 further includes a rotation gear adjustment assembly 15. The rotation gear adjustment assembly 15 includes a gear adjustment lever 151, a moving member 152, and a gear limiting switch 153. The fixed assembly 13 further includes a base plate 133. A cavity is formed between the base plate 133 and the fixed plate 131. The moving member 152 and the gear limiting switch 153 are disposed within this cavity. The gear adjustment lever 151 is movably connected to the base plate 133. One end of the gear adjustment lever 151 extends into the cavity and abuts against the moving member 152, while the other end is exposed outside the base plate 133. The end of the moving member 152 away from the gear adjustment lever 151 is adjacent to the gear limiting switch 153. When the gear adjustment lever 151 is switched to a first position, the moving member 152 presses and activates the gear limiting switch 153, turning it off. When the gear adjustment lever 151 is switched to a second position, the moving member 152 moves away from the gear limiting switch 153, turning the gear limiting switch 153 on, thereby switching the rotation gear of the rotating member 123.

In some aspects, the side of the gear adjustment lever 151 near the moving member 152 is provided with an actuating protrusion 154. The moving member 152 is provided with a first engagement groove 155 and a second engagement groove 156. The area between the first engagement groove 155 and the second engagement groove 156 is a sloped surface structure. The actuating protrusion 154 slidably connects with this sloped surface structure, enabling movement and switching between the first engagement groove 155 and the second engagement groove 156. When the actuating protrusion 154 slides from the first engagement groove 155 to the second engagement groove 156, it pushes the moving member 152 to press and activate the gear limiting switch 153, turning it off. When the actuating protrusion 154 slides from the second engagement groove 156 to the first engagement groove 155, it pushes the moving member 152 away from the gear limiting switch 153, turning it on; thus achieving gear switching.

In some aspects, the inner side of the second rotating shell 12812 is provided with a first rotation limiting protrusion 12814. The moving member 152 is further provided with a second rotation limiting protrusion 157. When the actuating protrusion 154 is in the first engagement groove 155, the second rotation limiting protrusion 157 lies on the rotation path of the first rotation limiting protrusion 12814. When the actuating protrusion 154 is in the second engagement groove 156, the second rotation limiting protrusion 157 moves away from the rotation path of the first rotation limiting protrusion 12814. When the second rotation limiting protrusion 157 is on the rotation path of the first rotation limiting protrusion 12814, structural interference exists between them, limiting the rotation travel of the adjustment member 124. Thus, the rotation travel of the rotating member 123 can be adjusted via the gear adjustment lever 151.

As used in the claims, the indefinite articles "a" and "an" should be understood to mean "one or more" unless explicitly stated otherwise or unless the context clearly dictates a singular interpretation. The use of these articles does not limit the claimed invention to a single instance of the referenced element but rather encompasses multiple instances where applicable.

What is claimed is:

1. A rotatable control assembly, comprising:
a fixed assembly;
a rotating assembly comprising a rotating member, an adjustment member, and a rotating shaft, wherein the rotating member is rotatably connected to the fixed assembly via the rotating shaft;
a damping assembly comprising a pressure-applying member and a damping member, wherein the damping member is located between the fixed assembly and the pressure-applying member, the pressure-applying member is rotatably disposed on the rotating shaft and is configured to abut against the damping member;
wherein the pressure-applying member is configured to axially move relative to the rotating shaft in response to a rotation of the pressure-applying member, and the adjustment member is disposed on the pressure-applying member; and
wherein the adjustment member is configured to drive the pressure-applying member to rotate in response to an external force, causing the pressure-applying member to axially move relative to the rotating shaft and abut against the damping member to change a contact area between the damping member and the fixed assembly.

2. The rotatable control assembly according to claim 1, wherein the damping member comprises a damping part and a transmission part; and
wherein the damping part is disposed between the transmission part and the fixed assembly, and the rotating member is fixedly connected to the rotating shaft.

3. The rotatable control assembly according to claim 2, one side of the transmission part is configured to abut against the pressure-applying member, and at least one elastic member is disposed between another side of the transmission part and the damping part; and
wherein an axial movement of the pressure-applying member is configured to press the transmission part, causing the transmission part to compress the elastic member, thereby pressing the damping part toward the fixed assembly.

4. The rotatable control assembly according to claim 2, wherein the transmission part is located between the damping part and the pressure-applying member, and is configured to abut respectively against the damping part and the pressure-applying member; and
wherein an axial movement of the pressure-applying member is configured to press the transmission part, causing the transmission part to press the damping part toward the fixed assembly.

5. The rotatable control assembly according to claim 2, wherein the rotating member is provided with a through hole, the transmission part is configured to pass through the through hole, and the transmission part is located between the damping part and the pressure-applying member.

6. The rotatable control assembly according to claim 5, wherein the rotating member comprises a mounting part and one or more limiting parts;
wherein the one or more limiting parts extend toward the rotating shaft to connect to an outer wall of the mounting part; and
wherein the rotating shaft is fixedly inserted through the mounting part, the transmission part comprises one or more first limiting grooves, and the one or more limiting parts correspond one-to-one with the first limiting grooves, with each limiting part being configured to be accommodated in a corresponding one of the one or more first limiting grooves.

7. The rotatable control assembly according to claim 2, wherein the rotating member comprises one or more protrusions, the damping part comprises one or more second limiting grooves, and the one or more protrusions are accommodated in the one of the second limiting groove, enabling the damping part to rotate with the rotating member.

8. The rotatable control assembly according to claim 1, wherein the adjustment member comprises an adjustment knob and a first connector;
wherein the rotating member is configured with an accommodating groove on a side facing away from the fixed assembly;
wherein the adjustment knob is accommodated in the accommodating groove;
wherein the first connector is fixedly connected to the adjustment knob, and the first connector is shape-fitted with the pressure-applying member; and
wherein a rotation of the adjustment knob is configured to drive the first connector to rotate, and a rotation of the first connector is configured to drive the pressure-applying member to rotate.

9. The rotatable control assembly according to claim 8, wherein one of the first connector and the rotating member is provided with a detent ball on a side facing another one, and another one of the first connector and the rotating member is provided with multiple limiting detent grooves adapted to a rounded end of the detent ball; and
wherein rotating the adjustment knob enables the detent ball to move from one limiting detent groove to another limiting detent groove among the limiting detent grooves.

10. The rotatable control assembly according to claim 9, wherein the rotating member comprises a first rotating member and a second rotating member, the second rotating member is rotatably disposed on the fixed assembly via the rotating shaft, and the first rotating member is fixedly connected to the second rotating member;
wherein the accommodating groove is provided on the first rotating member, and a bottom of the accommodating groove comprises a mounting hole;
wherein the adjustment knob comprises a hand-grip part and a connection part;
wherein the first connector comprises a protrusion part and an annular part, and the hand-grip part is connected to the connection part;
wherein the protrusion part passes through the mounting hole and is fixedly connected to the connection part, the protrusion part is shape-fitted with the pressure-applying member, and the annular part is disposed on an outer side of the protrusion part; and
wherein the detent ball is mounted on the annular part.

11. The rotatable control assembly according to claim 10, wherein the second rotating member comprises a first rotating part and a second rotating part, the first rotating part is fixedly connected to the second rotating part, and the second rotating part is fixedly connected to the first rotating member and is fixedly connected to the rotating shaft;
wherein the damping member comprises a damping part;
wherein a movement groove is provided between the first rotating part and the second rotating part, an end of the damping member away from the rotating shaft is disposed in the movement groove, and the first rotating part, the damping part, and the second rotating part are radially limited relative to the rotating shaft; and
wherein the damping part is configured to move axially relative to the first rotating part and the second rotating part within the movement groove.

12. A lens parameter adjustment device, comprising a main body and the rotatable control assembly according to claim 1, wherein a side of the fixed assembly facing away from the rotating member is connected to the main body, a first communication module is disposed on a side of the fixed assembly facing the main body, and a second communication module is disposed on a side of the main body facing the fixed assembly; and
wherein the first communication module and the second communication module are configured to be electrically connected.
